(19) United States
(12) Patent Application Publication
(10) Pub. No.: US 2025/0269303 A1
(43) Pub. Date: Aug. 28, 2025

(54) Filter Assembly

(71) Applicant: Illinois Tool Works Inc., Glenview, IL (US)

(72) Inventors: Sylvain Martineau, Vineuil saint Firmin (FR); Etienne Piot, Chamant (FR); Franck Couty, Senlis (FR); Guillaume Lefebvre, Chazay d’Azergues (FR)

(21) Appl. No.: 19/058,203

(22) Filed: Feb. 20, 2025

(30) Foreign Application Priority Data
Feb. 22, 2024 (FR) 2401740
Jan. 24, 2025 (FR) 2500749

(51) Int. Cl. B01D 29/31; B01D 29/96

(52) U.S. Cl. CPC B01D 29/31; B01D 29/96

(57) ABSTRACT

The disclosure relates to a filter assembly for a windshield washer fluid reservoir. The assembly includes a tubular piece to be connected to a pump and a hollow filter element with an inlet attached to the tubular piece and in fluid communication with it. The hollow filter element, when inserted through a hole in the windshield washer fluid reservoir, adopts an insertion configuration, in which it is folded to at least partially surround the tubular piece. The hollow filter element elastically returns to an operating configuration in which it protrudes radially from the tubular piece.

### RELATED APPLICATIONS

The present application claims the benefit of French Patent Application Nos. 2401740, filed Feb. 22, 2024, and 2500749, filed Jan. 24, 2025, each titled “Filter Assembly,” the contents of which are hereby incorporated by reference.

### TECHNICAL FIELD OF THE DISCLOSURE

The present disclosure generally relates to filter assemblies. More specifically, though not exclusively, the present disclosure relates to filter assemblies for windshield washer fluid reservoirs.

### BACKGROUND

Filter assemblies for fluid reservoirs are common and normally comprise a hollow filter element located inside the reservoir, which is connected to a pump to draw fluid from the reservoir into the pump through the filter element. This hollow filter element normally comprises a rigid support structure that keeps the filter element from collapsing when exposed to a negative pressure differential.

### SUMMARY

The present disclosure relates generally to a filter assembly, substantially as illustrated by and described in connection with at least one of the figures, as set forth more completely in the claims. The present disclosure aims to provide a filter assembly that is easier to install.

### DESCRIPTION OF THE DRAWINGS

The foregoing and other objects, features, and advantages of the devices, systems, and methods described herein will be apparent from the following description of particular examples thereof, as illustrated in the accompanying figures; where like or similar reference numbers refer to like or similar structures. The figures are not necessarily to scale, emphasis instead being placed upon illustrating the principles of the devices, systems, and methods described herein.

FIG. 1 illustrates a perspective view of a filter assembly for a windshield washer fluid reservoir as seen from above.

FIG. 2 illustrates a perspective view of a filter assembly for a windshield washer fluid reservoir as seen from below.

FIG. 3 illustrates a perspective cross-sectional view of the filter assembly shown in FIGS. 1 and 2.

FIG. 4 illustrates a perspective view of the filter section of the filter assembly shown in FIGS. 1 to 3.

FIG. 5 illustrates a perspective view of the filter section shown in FIG. 4, with the lowermost part of the bottom sheet omitted to show the serrated spacer on the tubular piece.

FIG. 6 illustrates a perspective view of the filter assembly shown in FIGS. 1 to 3 just before it is inserted into the reservoir hole.

FIG. 7 illustrates a cross-sectional view of the assembly as shown in FIG. 6.

FIG. 8 illustrates a similar view to the one shown in FIG. 7, with the filter assembly inserted into the reservoir opening.

FIG. 9 illustrates a similar view to the ones shown in FIGS. 7 and 8, showing the filter assembly fully installed in the reservoir.

### DETAILED DESCRIPTION

References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Recitation of ranges of values herein are not intended to be limiting, referring instead individually to any and all values falling within and/or including the range, unless otherwise indicated herein, and each separate value within such a range is incorporated into the specification as if it were individually recited herein. In the following description, it is understood that terms such as “first,” “second,” “top,” “bottom,” “side,” “front,” “back,” and the like are words of convenience and are not to be construed as limiting terms. For example, while in some examples a first side is located adjacent or near a second side, the terms “first side” and “second side” do not imply any specific order in which the sides are ordered.

The terms “about,” “approximately,” “substantially,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the disclosure. The use of any and all examples, or exemplary language (“e.g.,” “such as,” or the like) provided herein, is intended merely to better illuminate the disclosed examples, and does not pose a limitation on the scope of the disclosure. The terms “e.g.,” and “for example” set off lists of one or more non-limiting examples, instances, or illustrations. No language in the specification should be construed as indicating any unclaimed element as essential to the practice of the disclosed examples.

The term “and/or” means any one or more of the items in the list joined by “and/or.” As an example, “x and/or y” means any element of the three-element set {(x), (y), (x, y)}. In other words, “x and/or y” means “one or both of x and y.” As another example, “x, y, and/or z” means any element of the seven-element set {(x), (y), (z), (x, y), (x, z), (y, z), (x, y, z)}. In other words, “x, y, and/or z” means “one or more of x, y, and z.”

The disclosure relates to a filter assembly, for example for a windshield washer fluid reservoir, the assembly comprising a hollow filter element configured, when inserted through a hole in the windshield washer fluid reservoir, to adopt an insertion configuration in which it is folded and to elastically return to an operating configuration in which it protrudes radially.

The filter assembly can comprise a tubular piece to be connected to a pump. The hollow filter element can comprise an inlet. The inlet can be attached to the tubular piece and/or can be in fluid communication with the tubular piece.

The hollow filter element can be folded to at least partially surround the tubular piece in the insertion configuration. The hollow filter element can protrude radially from the tubular piece in the operating configuration.

The disclosure also relates to a filter assembly for a windshield washer fluid reservoir, the assembly comprising: a tubular piece to be connected to a pump, and a hollow filter element with an inlet attached to the tubular piece and in fluid communication with it; the hollow filter element being configured, when inserted through a hole in the windshield washer fluid reservoir, to adopt an insertion configuration in which it is folded to at least partially surround the tubular piece and to elastically return to an operating configuration in which it protrudes radially from the tubular piece.

The hollow filter element can be made of at least one sheet, for example a pair of sheets. One or more parts or regions of the sheet(s), for example one or more edge parts or regions, can be attached to each other. The sheets can be attached to each other along their edges.

More specifically, the hollow filter element can be made of a pair of sheets attached to each other along their edges.

The tubular piece can comprise a spacer. The spacer can extend into or inside the hollow filter element, for example to keep it from collapsing or sagging.

More specifically, the tubular piece can comprise a spacer extending into the hollow filter element to keep it from collapsing or sagging.

The spacer can be provided or even made by an extension of the tubular piece. The extension can comprise one or more, for example a plurality, of circumferentially-spaced protuberances or ridges. The extension can comprise one or more, for example a plurality, of circumferentially-spaced grooves or gaps. The extension can comprise a series of alternating protuberances or ridges and grooves or gaps, for example on its circumference or its edge.

The extension can comprise a series of spacer fins, which can be circumferentially spaced around the tubular piece. The spacer fins can be radially oriented or even radiate around the tubular piece. The spacer fins can be radially connected between each other. The extension can provide or form flow channels between the spacer fins. The extension can be serrated.

More specifically, the spacer can be provided by a serrated extension of the tubular piece.

The assembly can comprise a dip tube. The dip tube can comprise an end, for example a first end, that can be connected to the tubular piece. The dip tube can be fitted or housed in the tubular piece. The dip tube can also be welded to the tubular piece. In some examples, the dip tube can be releasably connected to the tubular piece, for example by a bayonet, threaded or other suitable connection. The connection between the dip tube and the tubular piece can comprise sealing means, such as an O-ring.

The dip tube can comprise an end, for example a second end, that can have sealing means, for example for sealed engagement with the hole in the windshield washer fluid reservoir. Alternatively, the sealing means can be located between the ends of the dip tube, for example over at least part of its length. The person skilled in the art will understand that several other positions are also possible without departing from the scope of the claims.

The dip tube can have a length that can be configured to position the hollow filter element next to a bottom of the windshield washer fluid reservoir.

More specifically, the assembly can comprise a dip tube with a first end that is connected to the tubular piece and a second end with sealing means for sealed engagement with the hole in the windshield washer fluid reservoir, in which the dip tube has a length configured to position the hollow filter element next to a bottom of the windshield washer fluid reservoir.

The sealing means can comprise a gasket or a sealing washer. The dip tube can comprise a head, which can be enlarged. The sealing means can be located between the head and the tubular piece. The sealing means can be configured to be gripped and/or compressed, when in use, between the reservoir and the head of the dip tube, for example to seal the assembly to the reservoir. The head can be configured for connection to a pump.

For the avoidance of doubt, all the features described herein also apply to any aspect of the disclosure.

As part of this application, it is expressly provided that the various aspects, embodiments, examples and alternatives disclosed in the preceding paragraphs, in the claims and/or in the following description and drawings, and in particular the individual features thereof, can be taken separately or in any combination. In other words, all embodiments and/or features of any embodiment can be combined in any way, unless these features are incompatible.

In order to avoid any ambiguity, the terms “can”, “and/or”, “for example”, and any other similar term used in the present document must be interpreted as not limiting, such that any feature thus described is not necessarily required to be present. Indeed, any combination of optional features is expressly foreseen without departing from the scope of the disclosure, whether or not they are expressly claimed. The applicant reserves the right to amend any claim originally filed or to file any new claim accordingly, including the right to amend any claim originally filed to depend on and/or incorporate any feature of any other claim, though it is not originally claimed in this manner.

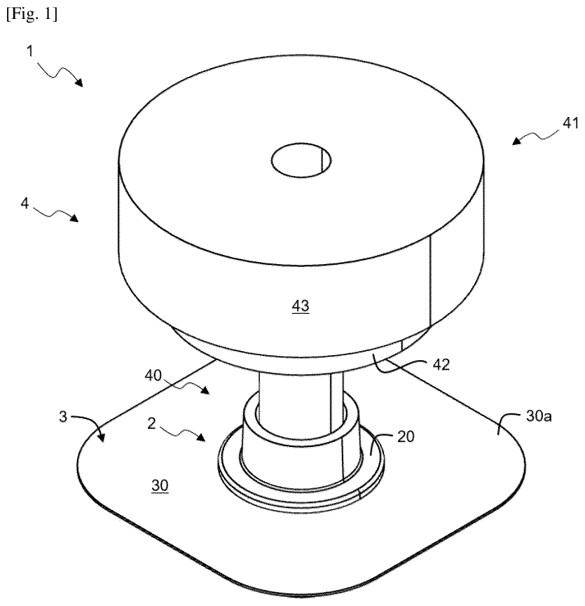

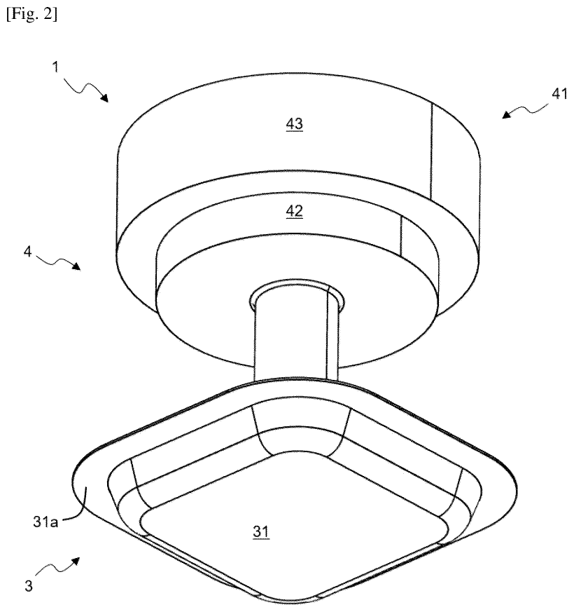

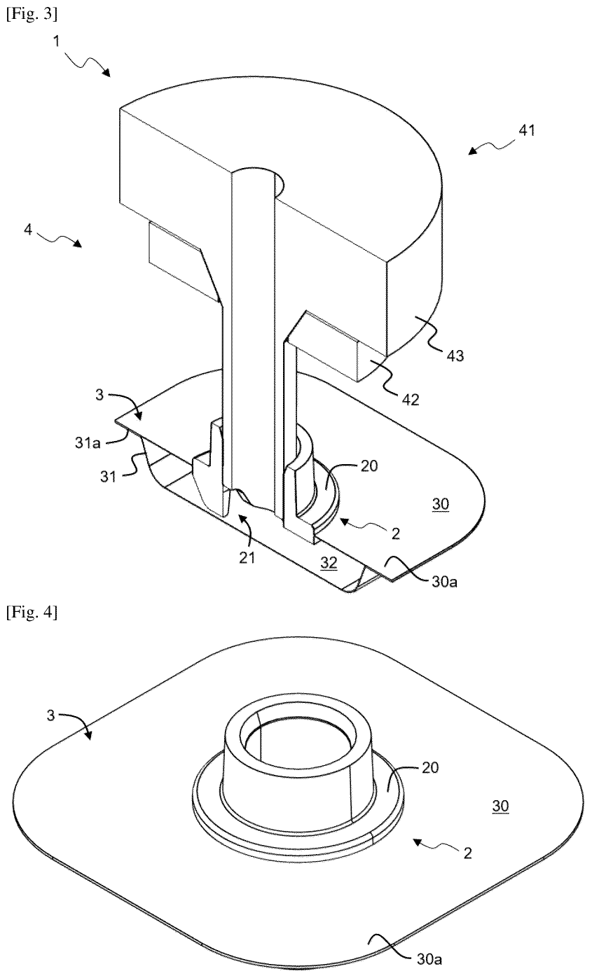

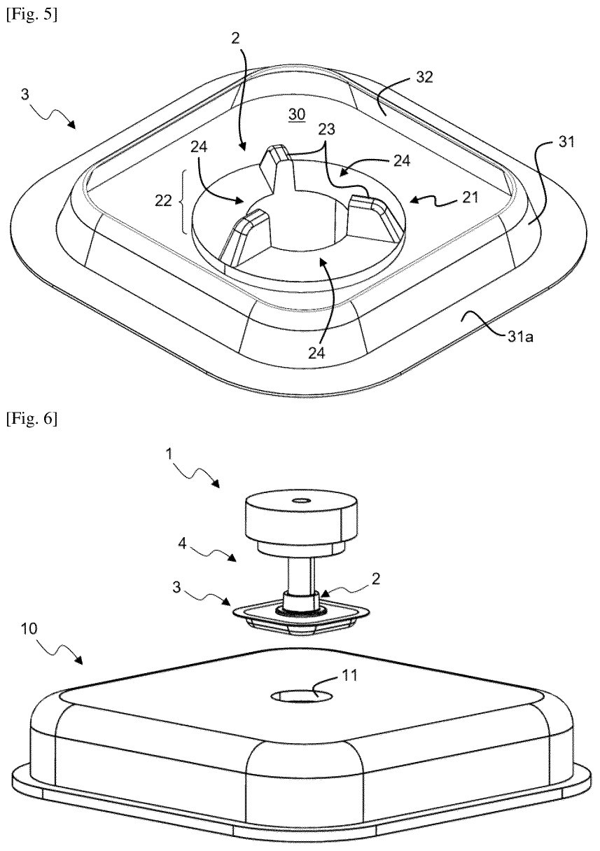

Now referring to FIGS. 1 to 6, a filter assembly 1 for a windshield washer fluid reservoir 10 can be seen. The assembly comprises a tubular piece 2, a hollow filter element 3 with an inlet attached to, and in fluid communication with, the tubular piece 2, and a dip tube 4 with a first end 40 that is fitted or housed in the tubular piece 2 and a second end 41 to be connected to a pump (not illustrated).

However, in some examples, the dip tube 4 can be incorporated into or connected to the tubular piece 2 in another way, for example by welding or by a bayonet or threaded connection, and/or can comprise sealing means, such as an O-ring. In fact, the person skilled in the art will understand that the piston tube 4 can be omitted, the pump being connected to the tubular piece 2 in another way.

The hollow filter element 3 is made of a pair of sheets 30, 31 attached to each other along their edges 30a, 31a. The sheets 30, 31 are made of filter material and comprise a substantially flat top sheet 30 and a bottom sheet 31 forming a recess 32 to create a space between the sheets 30, 31 so that the hollow filter element 3 forms an envelope.

The tubular piece 2 comprises a radial flange 20 which sealingly grips the top sheet 30 of the hollow filter element 3, thus forming an inlet to the hollow filter element 3. In this example, the tubular piece 2 comprises a spacer 21 that extends into the hollow filter element 3 to keep it from collapsing.

The spacer 21 on the tubular piece 2 is provided by a serrated extension 22, which extends from the radial flange 20 inside the hollow filter element 3. More specifically, and as shown in FIG. 5, the serrated extension 22 is made up of a series of spacer fins 23 circumferentially spaced around the tubular piece 2 to form flow channels 24 between them. The spacer fins 23 keep the sheets 30, 31 separated from each other while allowing the fluid to flow through the flow channels 24.

In this example, the dip tube 4 comprises sealing means 42 and an enlarged head 43, and the sealing means 42 is in the form of a sealing washer located between the enlarged head 43 and the tubular piece 2. Alternatively, the sealing means 42 can be located over at least part of its length. The person skilled in the art will understand that several other positions are also possible.

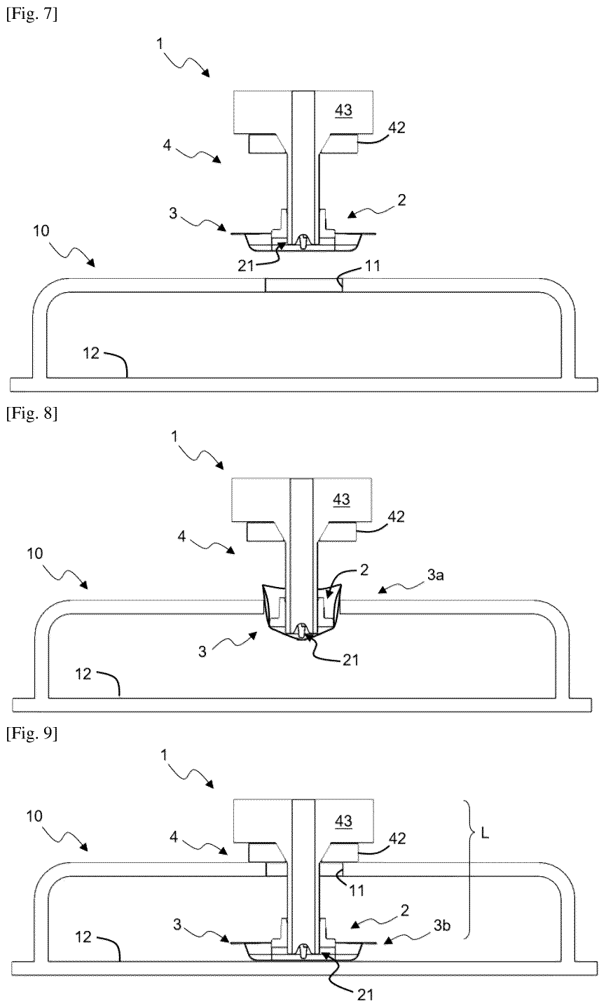

Now referring to FIGS. 7 to 9, it can be seen that the hollow filter element 3 is configured, when inserted through a hole 11 in the windshield washer fluid reservoir 10, to adopt an insertion configuration 3a (illustrated in FIG. 8), in which it is folded to at least partially surround the tubular piece 2. As shown in FIG. 9, the hollow filter element 3 is further configured to elastically return to an operating configuration 3b, in which it protrudes radially from the tubular piece 2.

As shown in FIG. 9, the dip tube 4 has a length L configured to position the hollow filter element 3 next to a bottom 12 of the windshield washer fluid reservoir 10. In addition, the sealing means 42 is gripped and compressed between the reservoir 10 and the enlarged head 43 of the dip tube 4 to seal the assembly 1 to the reservoir 10. The enlarged head 43 is configured for connection to a pump (not illustrated).

Throughout the description, the words “comprise” and “contain”, and variations thereof mean “including but not limited to”, and are not intended for (and do not exclude) other whole or partial parts, additives or components. Throughout the description, the singular includes the plural, unless the context requires otherwise. In particular, when the indefinite article is used, the specification should be understood to include the plural as well as the singular, unless the context requires otherwise.

While the present method and/or system has been described with reference to certain implementations, it will be understood by those skilled in the art that various changes may be made, and equivalents may be substituted without departing from the scope of the present method and/or system. In addition, many modifications may be made to adapt a particular situation or material to the teachings of the present disclosure without departing from its scope. For example, block and/or components of disclosed examples may be combined, divided, re-arranged, and/or otherwise modified. Therefore, the present method and/or system are not limited to the particular implementations disclosed. Instead, the present method and/or system will include all implementations falling within the scope of the appended claims, both literally and under the doctrine of equivalents.

### List of Reference Numbers

1 filter assembly
10 windshield washer fluid reservoir
2 tubular piece
20 radial flange
21 spacer
22 serrated extension
23 spacer fin
24 flow channel
3 hollow filter element
30 top sheet
30a top sheet edge
31 bottom sheet
31a bottom sheet edge
32 recess
4 dip tube
40 first end
41 second end
42 sealing means
43 expanded head

What is claimed is:

1. A filter assembly (1) for a windshield washer fluid reservoir (10), the assembly comprising:
a tubular piece (2) to be connected to a pump; and
a hollow filter element (3) with an inlet attached to the tubular piece (2) and in fluid communication with it;
the hollow filter element (3) being configured, when inserted through a hole (11) in the windshield washer fluid reservoir (10), to adopt an insertion configuration (3a), in which it is folded to at least partially surround the tubular piece (2), and to elastically return to an operating configuration (3b), in which it protrudes radially from the tubular piece (2).

2. The filter assembly (1) according to claim 1, in which the hollow filter element (3) is made of a pair of sheets (30, 31) attached to each other along their edges (30a, 31a).

3. The filter assembly (1) according to claim 1, in which the tubular piece (2) comprises a spacer (21) extending into the hollow filter element (3) to keep it from collapsing.

4. The filter assembly (1) according to claim 3 in which the spacer (21) is provided by a serrated extension (22) of the tubular piece (2).

5. The filter assembly (1) according to claim 3, in which one or the extension (22) provided by the spacer (21) comprises a series of spacer fins (23) circumferentially spaced around the tubular piece (2) to form flow channels between said spacer fins (23).

6. The filter assembly (1) according to claim 1, further comprising a dip tube (4) with a first end (40) that is connected to the tubular piece (2) and a second end (41) with sealing means (42) for sealed engagement with the hole (11) in the windshield washer fluid reservoir (10), in which the dip tube (4) has a length (L) configured to position the hollow filter element (3) next to a bottom (12) of the windshield washer fluid reservoir (10).

7. The filter assembly (1) according to claim 6, in which the dip tube (4) comprises a head (43), in which the sealing means (42) is between the head (43) and the tubular piece (2), and in which the sealing means (42) is configured to be gripped and/or compressed between the windshield washer fluid reservoir (10) and the head (43) of the dip tube (4), when in use, to seal said filter assembly (1) to said windshield washer fluid reservoir (10).
